(19) United States
(12) Patent Application Publication
(10) Pub. No.: US 2011/0164911 A1
(43) Pub. Date: Jul. 7, 2011

(54) Paper feed device and image formation apparatus using the same

(75) Inventor: Guo Li, Shanghai (CN)

(73) Assignee: Ricoh Company, Ltd.

(21) Appl. No.: 12/926,633

(22) Filed: Dec. 1, 2010

(30) Foreign Application Priority Data
Jan. 6, 2010 (CN) 201010003614.7

(51) Int. Cl. B41J 11/42; B65H 5/00

(52) U.S. Cl. 400/582; 271/10.13

(57) ABSTRACT

Disclosed are a paper feed device and an image formation apparatus using the same. The device comprises a drive transmission unit disposed on one end of a rotation shaft, including a clutch gear, a control unit, and a spring; a control unit stopper fixedly disposed on the control unit; and an electromagnetic absorber including a detent. When the detent is located at a brake-off position, the detent and the control unit stopper are separated. When the detent is located at a braking position, the detent makes contact with the control unit stopper, and stops the rotation of the control unit.

### BACKGROUND OF THE INVENTION

1. Field of the Invention

The present invention relates to a paper feed device, and more particularly relates to a paper feed device used in an image formation apparatus and an image formation apparatus using the paper feed device.

2. Description of the Related Art

In conventional techniques, a paper feed device used in an image formation apparatus usually employs cooperative action jointly undertaken by a mechanical spring clutch and an electromagnetic absorber to control the rotation behavior and the stop behavior of a paper feed roller. In a conventional mechanical spring clutch, a load shaft (i.e. a rotation shaft) of a paper feed roller is connected to a clutch gear by using a spring, and acts (i.e. rotates) according to the rotation transmitted from a drive gear chain in an image formation apparatus to the clutch gear; by controlling, using a control unit stopper controlled by the electromagnetic absorber, whether the rotation of a gear is transmitted to the rotation shaft, the control of the behavior of the paper feed roller can be achieved.

However, in the conventional techniques, for example, in a case of feeding a paper sheet, a portion of the paper sheet is first fed by a paper feed roller, and then control of the follow-on paper feed behavior is carried out by a transport roller located after the paper feed roller. But since the rotation of the paper feed roller stops and there is a friction force between the paper feed roller and a portion of the paper sheet that has not been sent away yet, the paper feed roller receives a load force along the rotation direction.

When the conventional mechanical spring clutch works, the control unit stopper engages with a detent on the electromagnetic absorber, so the gear is stopped; however, due to the above-mentioned reason (i.e. the rotation shaft receives a load at this time), rotation occurs along the rotation direction in the rotation shaft. At this time, since an end of the spring is fixedly connected to the control unit and another end of the spring is fixedly connected with respect to the rotation shaft, in a situation where there is no rotation in the control unit and the rotation shaft rotates, an unexpected torsion force may occur in the spring; this unexpected torsion force may cause the spring to create torsion deformation, and may cause the spring to stop working in this state.

In other words, in the conventional techniques, torsion deformation may be created in the spring in a resting state due to a rotation load of the rotation shaft, and a long-time internal load of the spring may cause the spring to undergo deformation; therefore the life duration of the spring may be shortened, and then the life duration of the clutch may be shortened too.

### SUMMARY OF THE INVENTION

The disadvantages of the prior art are overcome by the present invention.

One aim of the present invention is proposing a paper feed device in which an improved structure is included. By using the improved structure, it is possible to not cause an internal spring coil to undergo deformation while controlling a paper feed roller. Therefore the life duration of clutch is not shortened.

Another aim of the present invention is proposing an image formation apparatus using the paper feed device.

According to one aspect of the present invention, a paper feed device is provided. The paper feed device comprises a drive transmission unit configured to be disposed on one end of a rotation shaft, including a clutch gear, a control unit, and spring; a control unit stopper disposed on the control unit; and an electromagnetic absorber including a detent. The clutch is axially oriented with respect to the rotation shaft and is able to rotate around the rotation shaft, the control unit is used for fixedly connecting the spring to the clutch gear, one end of the spring is fixedly connected to the control unit, and another end of the spring is fixedly connected with respect to the rotation shaft. When the clutch gear is driven to rotate, the clutch gear drives the rotation shaft to rotate by using the spring. When the electromagnetic absorber is in a conducting state, the detent is located at one position of a brake-off position and a braking position; when the electromagnetic absorber is in a non-conduction state, the detent is located at another position of the brake-off position and the braking position. When the detent is located at the brake-off position, the control unit stopper and the rotation shaft stopper are separate; when the detent is located at the braking position, the rotation of the control unit is stopped by the control unit stopper. Under the latter circumstance, from the time when the rotation of the control unit stops, the rotation shaft continues to rotate a predetermined angle with regard to the control unit so that the rotation shaft stopper can make contact with the control unit stopper, and then the detent can stop the rotation of the rotation shaft by using the control unit stopper.

Furthermore the drive transmission unit further includes a rotation shaft drive unit. The rotation shaft drive unit mates with one end of the rotation shaft and is fixedly connected to this end of the rotation shaft along a rotation direction. The spring mates with the rotation shaft drive unit; the control unit mates with the spring. An other end of the spring is fixedly connected to the rotation shaft drive unit along the rotation direction so as to achieve the fixed connection of the other end of the spring with respect to the rotation shaft. The rotation shaft stopper is fixedly disposed on the rotation shaft drive unit so as to achieve the fixed connection of the rotation shaft stopper with respect to the rotation shaft.

Furthermore the predetermined angle through which the rotation shaft continues to rotate with regard to the control unit from the time when the rotation of the control unit stops is 5 degrees ±3 degrees.

Since the paper feed device having the above-mentioned structure can utilize the electromagnetic absorber to cause the rotation of the rotation shaft and the rotation of the control unit to stop, the end of the spring on the side of the rotation shaft cannot rotate together with the paper feed roller; that is, it is possible to cause the drive transmission unit to stop in a state where the spring does not receive a load so that shortening of the life duration of the drive transmission unit can be avoided. Furthermore since the rotation of the control unit and the rotation of the rotation shaft do not stop together, i.e. the rotation of the rotation shaft stops after the rotation of the control unit stops, a stopping force of the detent of the electromagnetic absorber is reduced and it is easy to control the relative position between the rotation shaft and the control unit.

According to another aspect of the present invention, an image formation apparatus having the paper feed device provided by the present invention is provided.

### BRIEF DESCRIPTION OF THE DRAWINGS

FIG. 1 illustrates the installation position of a paper feed device in an image formation apparatus according to a first embodiment of the present invention.

FIG. 2 is a structural diagram of a paper transport unit and a drive transmission unit of the paper feed device according to the first embodiment of the present invention.

FIG. 3 is an exploded perspective diagram of the drive transmission unit and an electromagnetic absorber of the paper feed device according to the first embodiment of the present invention.

FIG. 4 is a perspective diagram of the drive transmission unit and the electromagnetic absorber of the paper feed device according to the first embodiment of the present invention; in FIG. 4, a detent of the electromagnetic absorber is located at a brake-off position.

FIG. 5 is a perspective diagram of the drive transmission unit of the paper feed device, according to the first embodiment of the present invention.

FIG. 6 is an axial end view of the drive transmission unit of the paper feed device according to the first embodiment of the present invention.

FIG. 7 is a perspective diagram of a drive transmission unit of a paper feed device according to a second embodiment of the present invention.

### DETAILED DESCRIPTION OF THE PREFERRED EMBODIMENTS

Hereinafter, embodiments of the present invention will be concretely described with reference to the drawings.

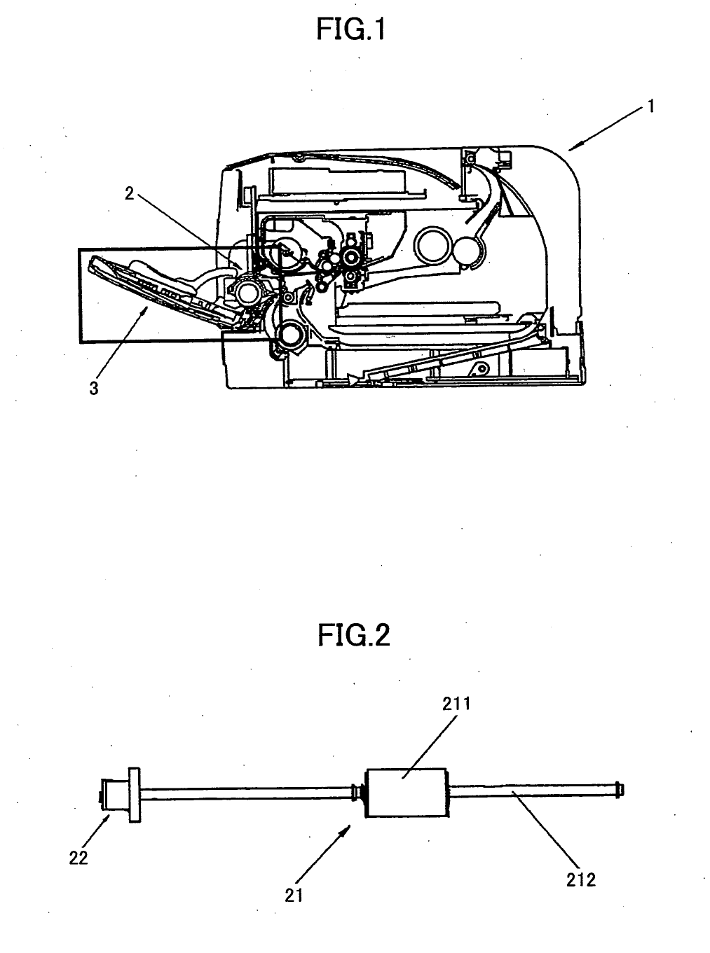

As shown in FIG. 1, an image formation apparatus 1 according to a first embodiment of the present invention comprises a paper feed tray 3 and a paper feed device 2. One or more paper sheets needing to be printed are stacked on the paper feed tray 3, and the paper feed tray 3 is pivotally disposed in an opening on one sidewall of the image formation apparatus 1. When the paper feed tray 3 opens, the opening of the image formation apparatus 1 opens toward the outside. The paper feed device 2 is disposed inside the image formation apparatus 1 and is located near a pivot around which the paper feed tray 3 pivots so that the paper sheets can be transported from the paper feed tray 3 to an imaging unit (not shown in the drawings) inside the image formation apparatus 1.

As shown in FIG. 2, the paper feed device 2 includes a paper transport unit 21; the paper transport unit 21 includes a paper feed roller 211 and a rotation shaft (i.e. a load shaft) 212. The rotation shaft 212 extends along the direction orthogonal to the direction of paper feed carried out by the paper feed device 2, and two ends of the rotation shaft 212 are supported by two sidewalls (not shown in the drawings) of the image formation apparatus 1, respectively. The paper feed roller 211 has shape of a cylinder extending along the rotation shaft 212, and can rotate around the rotation shaft 212 as the rotation shaft 212 rotates. The main body of the paper feed roller 211 is made of an elastic material such as gum, etc. In a case where the paper sheet on the paper feed tray 3 makes contact with the paper feed roller 211, the paper sheet can be transported when the paper feed roller 211 rotates.

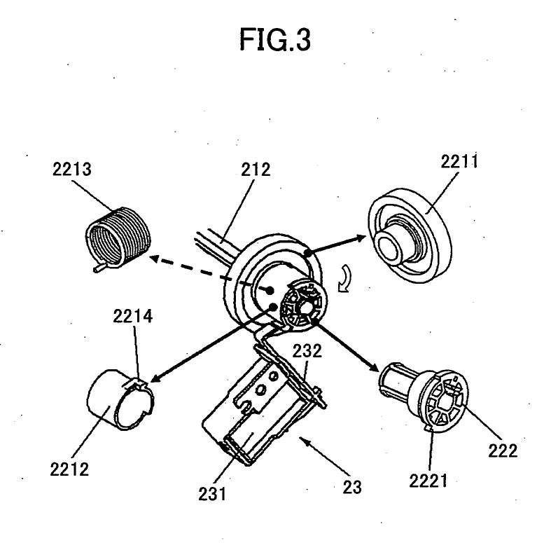

The paper feed device 2 further includes a drive transmission unit 22 that is disposed on one end of the rotation shaft 212. As shown in FIG. 3, the drive transmission unit 22 includes a clutch gear 2211, a control unit 2212, and a spring 2213. The clutch gear 2211 is axially oriented with respect to the rotation shaft 212, and is able to rotate around the rotation shaft 212. The control unit 2212 is used for letting the spring 2213 be able to be fixedly connected to the clutch gear 2211. One end of the spring 2213 is fixedly connected to the control unit 2212; another end of the spring 2213 is fixedly connected with respect to the rotation shaft 212. The clutch gear 2211 receives a drive force from a motor (not shown in the drawings) of the image formation apparatus 1; in a case where the clutch gear 2211 is driven by the drive force to rotate, when the control unit 2212 controls the spring 2213 to let it be fixedly connected to the clutch gear 2211, the rotation of the clutch gear 2211 makes the rotation shaft 212 rotate by using the spring 2213. On the control unit 2212, a control unit stopper 2214 is fixedly disposed.

The paper feed device 2 further includes an electromagnetic absorber 23 that includes a detent 232. When the electromagnetic absorber 23 is in a conducting state, the detent 232 is located at one of a brake-off position and a braking position, for example, the braking position; when the electromagnetic absorber 23 is in a non-conducting state, the detent 232 is located at another position of the brake-off position and the braking position, for example, the brake-off position. When the detent 232 is located at the brake-off position, the detent 232 and the control unit stopper 2214 are separated. When the detent 232 is located at the braking position, the detent 232 makes contact with the control unit stopper 2214, and causes the rotation of the control unit 2212 to stop by using the control unit stopper 2214. The control unit 2212 controls the spring 2213 to let it release its fixed connection with the clutch gear 2211 when the rotation of the control unit 2212 stops.

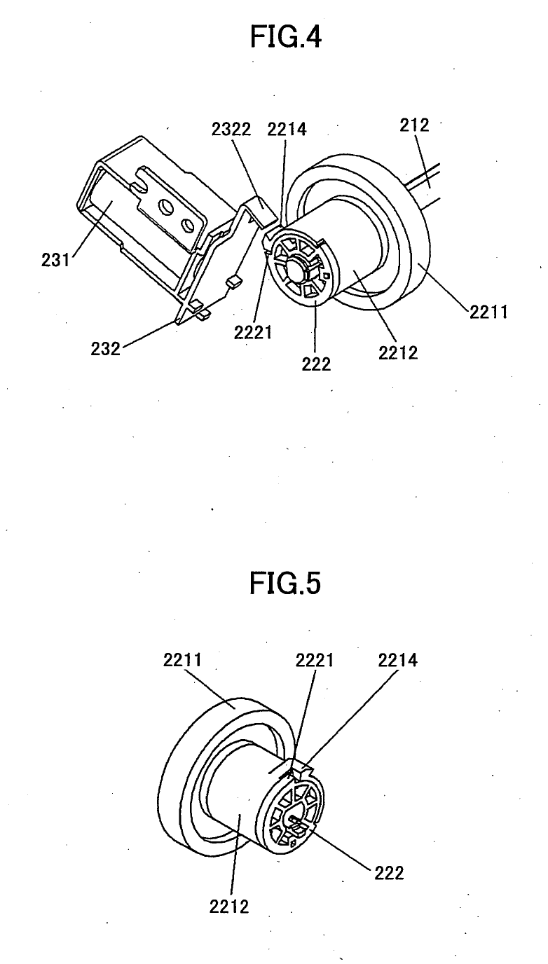

As shown in FIG. 4, the improvement of the paper feed device 2 in this embodiment further includes a rotation shaft stopper 2221 that is fixedly connected with respect to the rotation shaft 212. When the detent 232 is located at the brake-off position, the control unit stopper 2214 and the rotation shaft stopper 2221 are separated. When the detent 232 is located at the braking position, the rotation of the control unit 2212 is stopped due to the control unit stopper 2214; in this case, from the time when the rotation of the control unit 2212 stops, the rotation shaft 212 continues to rotate a predetermined angle with respect to the control unit 2212 so that the rotation shaft stopper 2221 can make contact with the control unit stopper 2214, and then the detent 232 can stop the rotation of the rotation shaft 212 by using the control unit stopper 2214.

As a concrete example, as shown in FIG. 3 and FIG. 4, the drive transmission unit 22 of the paper feed device 2 further includes a rotation shaft drive unit 222. The rotation shaft drive unit 222 mates with one end of the rotation shaft 212, and is fixedly connected to this end of the rotation shaft 212 along the rotation direction (represented by an arrow in FIG. 3). The spring 2213 mates with the rotation shaft drive unit 222; the control unit 2212 mates with the spring 2213. One end of the spring 2213 is fixedly connected to the control unit 2212 in a way where this end of the spring 2213 cannot move along the rotation direction so that this end of the spring 2213 cannot rotate with respect to the control unit 2212. Another end of the spring 2213 is fixedly connected to the rotation draft drive unit 222. The rotation shaft stopper 2221 is fixedly disposed on the rotation shaft drive unit 222 so that the rotation shaft stopper 2221 can be fixedly connected with respect to the rotation shaft 212. According to the basic concept of the embodiments of the present invention, although a few members are added in the above-mentioned concrete example, these members are not always necessary, and their formations are not limited to those as shown in FIG. 3 and FIG. 4.

By using the above-mentioned structure, the clutch gear 2211 causes the spring 2213 to rotate, then the spring 2213 causes the rotation shaft drive unit 222 to rotate, and then the rotation shaft drive unit 222 causes the rotation shaft 212 to rotate when the clutch gear 2211 receives a drive force from a motor of the image formation apparatus 1 and the control unit 2212 causes the spring 2213 to be fixedly connected to the clutch gear 2211.

In this embodiment, the control unit 2212 is a sleeve member. However, the control unit 2212 is not limited to this; those practiced in the art may arbitrarily choose the concrete formation of the control unit 2212 based on actual structures and actual demands.

In this embodiment, the rotation shaft drive unit 222 is formed by a few sleeve parts having different external diameters. More particularly, the rotation shaft drive unit 222 has a stair-like axial section (i.e. axial cross-section) in which the external diameter of the rotation shaft drive unit 222 gradually reduces from the end far away from the clutch gear 2211 and the external diameter of the sleeve part farthest away from the clutch gear 2211 is maximum; this maximum external diameter is desirably equal to the external diameter of the control unit 2212. The rotation shaft 212 is inserted into the rotation shaft drive unit 222 and is fixedly connected to the rotation shaft drive unit 222 along the rotation direction. Desirably two end faces of the rotation shaft 212 and the rotation shaft drive unit 222 far away from the clutch gear 2211 are in one plane after fixedly connecting the rotation shaft 212 and the rotation shaft drive unit 222. However, the present invention is not limited to this; those skilled in the art may arbitrarily choose the concrete formation of the rotation shaft drive unit 222 based on actual structures and actual demands.

In this embodiment, the spring 2213 is a single coil spring that mates with the part except the part having the maximum external diameter, of the rotation shaft drive unit 222 and is located inside the control unit 2212. However, it is possible to let the spring 2213 be plural coil springs or plural stripe-shaped leaf springs that may be distributed around the rotation shaft drive unit 222 along the length direction of the rotation shaft drive unit 222.

As shown in FIG. 3, the electromagnetic absorber 23 in this embodiment includes an electromagnetic coil 231 and the detent 232. The detent 232 has a substantially L-shaped cross-section and has an extension sheet 2322 that sticks out toward the direction away from a position where the electromagnetic coil 231 is located. The detent 232 is made of material which can be attracted by an electromagnetic force, for example, a metal plate, etc.

In this embodiment, the detent 232 is located at one end of the electromagnetic coil 231; in a case where the electromagnetic absorber 23 is in a conducting state, i.e. the electromagnetic coil 231 is in a conducting state, the detent 232 is attracted by an electromagnetic force generated by the electromagnetic coil 231 so as to move from the brake-off position to the braking position. At the brake-off position, the detent 232 cannot make contact with the control unit stopper 2214; on the other hand, at the braking position, the detent 232 can make contact with the control unit stopper 2214 so that the rotation of the control unit 2212 can be stopped due to the control unit stopper 2214. Furthermore, from the time when the rotation of the control unit 2212 stops, the rotation shaft 212 continues to rotate a predetermined angle with respect to the control unit 2212 so that the rotation shaft stopper 2221 can make contact with the control unit stopper 2214; as a result, the detent 232 can stop the rotation of the rotation shaft 212 by using the control unit stopper 2214. However, the present invention is not limited to this; those practiced in the art may make numerous modifications based on actual structures and actual demands. For example, in a different structure, after applying current to the electromagnetic coil 231, a rejection force can be created for rejecting the detent 232 so that the detent 232 can be moved along the direction away from the electromagnetic coil 231; as a result, the detent 232 can be moved to a position where the detent 232 is able to make contact with the control unit stopper 2214.

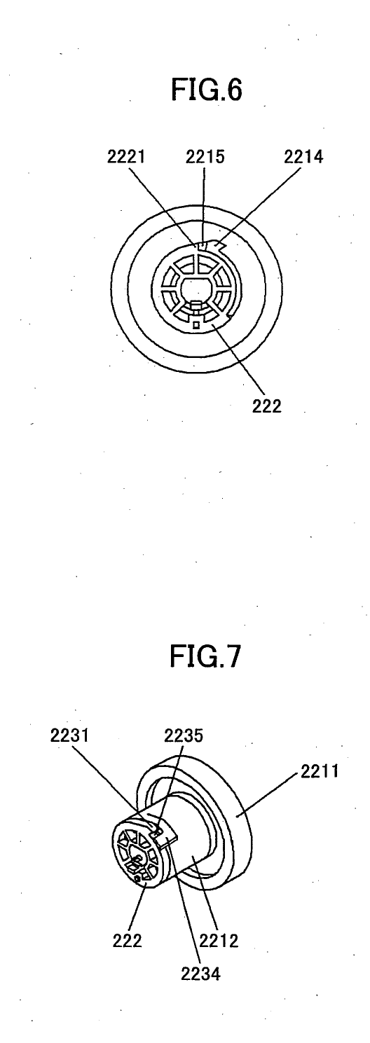

As shown in FIGS. 3-5, in this embodiment, the control unit stopper 2214 is formed at a position that is on the external wall of the control unit 2212 and is close to the part of the rotation shaft drive unit 222 having the maximum external diameter. The rotation shaft stopper 2221 is formed at a position that is on the external wall of the part of the rotation shaft drive unit 222 having the maximum external diameter, and is close to the control unit 2212. The control unit stopper 2214 and the rotation shaft stopper 2221 formed in this way are located at the positions approaching each other. In this embodiment, the control unit stopper 2214 is a boss sticking out toward the outside from the external wall of the control unit 2212; on the other hand, the rotation shaft stopper 2221 is a boss sticking out toward outside from the external wall of the rotation shaft drive unit 222. More particularly, in this embodiment, a recess is formed on the part of the rotation shaft drive unit 222 having the maximum external diameter; the recess has a salient that is formed on the downstream side along the rotation direction of the rotation shaft 212 and radially sticks out toward the outside from the external wall of the rotation shaft drive unit 222, and the salient serves as the rotation shaft stopper 2221. An extension is formed at a position of the control unit 2212; the position is close to the part of the rotation shaft drive unit 222 having the maximum external diameter. The extension may mate with the recess formed on the part of the rotation shaft drive unit 222 having the maximum external diameter, so that when the rotation shaft drive unit 222 mates with the control unit 2212, the extension of the control unit 2212 can mate with the recess formed on the part of the rotation shaft drive unit 222 having the maximum external diameter. Furthermore a tongue is formed at a position that is on the external wall of the control unit 2212 and is close to the part of the rotation shaft drive unit 222 having the maximum external diameter; the tongue extends along the axial direction of the control unit 2212 to the external wall of the extension on the upper stream side along the rotation direction of the control unit 2212, and the tongue serves as the control unit stopper 2214. Desirably when the rotation shaft drive unit 222 mates with the control unit 2212, two end faces of the control unit stopper 2214 and the rotation shaft drive unit 222 far away from the latch gear 2211 are in one plane; on the other hand, when the rotation shaft drive unit 222 mates with the control unit 2212, there is a gap 2215 between the control unit stopper 2214 and the rotation shaft stopper 2221 along the rotation direction of the rotation shaft drive unit 222. More particularly, in this embodiment, as shown in FIG. 6, two end faces of the control unit stopper 2214 and the rotation shaft stopper 2221, facing each other along the rotation direction of the rotation shaft drive unit 222, form radial planes extending along the axial direction of the rotation shaft drive unit 222, respectively. By using this kind of structure, it is possible to cause the detent 232 to make contact with the control unit stopper 2214 at the braking position so that the rotation of the control unit 2212 can be stopped due to the control unit stopper 2214. From the time when the rotation of the control unit 2212 stops, the rotation shaft 212 continues to rotate a predetermined angle with respect to the control unit 2212 so that the rotation shaft stopper 2221 can make contact with the control unit stopper 2214; as a result, the detent 232 can stop the rotation of the rotation shaft 212 by using the control unit stopper 2214. However, the present invention is not limited to this; those skilled in the art can make numerous modifications. In particular, the control unit stopper 2214 and the rotation shaft stopper 2221 may be formed at other positions of the control unit 2212 and the rotation shaft drive unit 222 by various means, respectively. For example, the control unit stopper 2214 may be formed at another position on the external wall of the control unit 2212, and the rotation shaft stopper 2221 may be formed on the end face of the rotation shaft drive unit 222 far away from the clutch gear 2211. That is, as long as the structure formed in this way can achieve the function required by the embodiments of the present invention, it is good.

In an initial state (i.e. a standby state where the image formation apparatus 1 does not need to carry out image formation, and the paper feed roller 211 does not need to rotate), current is not applied to the electromagnetic coil 231, and the detent 232 is located at the brake-off position. It is should be noted that at this brake-off position, the detent 232 is spatially located at a position close to the control unit stopper 2214 and the rotation shaft stopper 2221, but cannot make contact with the control unit stopper 2214 at all.

In a working state (i.e. a state where the image formation apparatus 1 carries out image formation), the spring 2213 is fixedly connected to the clutch gear 2211 due to the control unit 2212. As a drive force from a motor (not shown in the drawings) of the image formation apparatus 1 is transmitted to the clutch gear 2211, the clutch gear 2211 rotates and the rotation of the clutch gear 2211 is transmitted to the rotation shaft 212 via the spring 2213 and the rotation shaft drive unit 222 so that the paper feed roller 211 can rotate.

After the paper feed roller 211 rotates 360 degrees, the front end portion of the paper sheet is transported into the paper transportation roller located after the paper feed roller 211, and the paper feed roller 211 needs to stop. At this time, current is applied to the electromagnetic coil 231 so that an electromagnetic force can be created inside the electromagnetic coil 231; as a result, the detent 232 is moved toward the electromagnetic coil 231 from the brake-off position to the braking position. At this braking position, the detent 232 is located at a position where the detent 232 can make contact with the control unit stopper 2214. In particular, in this embodiment, the extension sheet 2322 of the detent 232 is located at a position where the extension sheet 2322 can make contact with the control unit stopper 2214. When the detent 232 makes contact with the control unit stopper 2214, the rotation of the control unit 2212 is stopped; at this time, the control unit 2212 causes the spring 2213 to release its fixed connection with the clutch gear 2211 so that the rotation of the clutch gear 2211 cannot be transmitted and the control unit 2212 is stopped. Furthermore, since there is the gap 2215 between the control unit stopper 2214 and the rotation shaft stopper 2221 along the rotation direction of the rotation shaft drive unit 222, from the time when the rotation of the control unit 2212 stops, the rotation shaft 212 continues to rotate a predetermined angle with respect to the control unit 2212 until the rotation shaft stopper 2221 makes contact with the control unit stopper 2214. In this embodiment, when the rotation shaft stopper 2221 makes contact with the control unit stopper 2214, the end face of the rotation shaft stopper 2221, facing the control unit stopper 2214 along the rotation direction of the rotation shaft drive unit 222, attaches to the corresponding end face of the control unit stopper 2214. When the rotation shaft stopper 2221 makes contact with the control unit stopper 2214, the rotation of the rotation shaft drive unit 222 is stopped, and then the rotation of the rotation shaft 212 is stopped. Therefore, in this way, the detent 232 can stop the rotation of the rotation shaft 212 by using the control unit stopper 2214.

In the first embodiment of the present invention, as shown in FIG. 6, there is the gap 2215 between the control unit stopper 2214 and the rotation shaft stopper 2221 along the rotation direction of the rotation shaft drive unit 222; this gap 2215 guarantees that the control unit 2212 and the rotation shaft drive unit 222 cannot stop rotating at the same time. That is, the rotation of the control unit 2212 first stops, and then the rotation of the rotation shaft drive unit 222 stops.

In this embodiment, by disposing the control unit stopper 2214 and the rotation shaft stopper 2221 on the control unit 2212 and the rotation shaft drive unit 222, respectively, it is possible to cause the control unit 2212 and the rotation shaft drive unit 222 to stop rotating by utilizing the electromagnetic absorber 23; therefore the end of the spring 2213, connecting to the rotation shaft drive unit 222 cannot rotate as the paper feed roller 211 rotates so that it is possible to let the paper feed device 2 stop in a state where the spring 2213 does not receive a load. As a result, the shortening of the life duration of the paper feed device 2 can be effectively avoided.

Furthermore, in this embodiment, the detent 232 first makes contact with the control unit stopper 2214 so that the rotation of the control unit 2212 is stopped; then the control unit stopper 2214 makes contact with the rotation shaft stopper 2221 so that the rotation of the rotation shaft drive unit 222 is stopped. By this way, a stopping force acting on the detent 232 can be effectively decreased and can be effectively averaged so that it is possible to avoid the drawback of a position gap of the detent 232 after long-term use. Furthermore, in the installation process, since it is possible to only adjust the positional relationship between the detent 232 and the control unit stopper 2214 or the positional relationship between the control unit stopper 2214 and the rotation shaft stopper 2221, the simultaneous adjustment of the positional relationship among the detent 232, the control unit stopper 2124, and the rotation shaft stopper 2221 can be avoided; as a result, the installation process can be simplified, and the alignment accuracy can be improved.

Furthermore, in this embodiment, the stopping behavior between the control unit stopper 2214 and the rotation shaft stopper 2221 is desirably as follows: the detent 232 first makes contact with the control unit stopper 2214; from the time when the control unit 2212 stops rotating, the rotation shaft 212 continues to rotate a predetermined angle with respect to the control unit 2212 until the rotation shaft stopper 2221 makes contact with the control unit stopper 2214. When the rotation shaft stopper 2221 makes contact with the control unit stopper 2214, the rotation of the rotation shaft drive unit 222 is stopped, and then the rotation of the rotation shaft is stopped. More particularly, in this embodiment, from the time when the control unit 2212 stops rotating, the predetermined angle through which the rotation shaft 212 continues to rotate with respect to the control unit 2212 is 5 degrees ±3 degrees. However, the present invention is not limited to this; those practiced in the art may arbitrarily choose the value of the predetermined angle based on actual structures and actual demands.

In this kind of structure, it is easy to control the relative position between the control unit 2212 and the rotation shaft drive unit 222 by setting the size of the gap 2215 between the control unit stopper 2214 and the rotation shaft stopper 2221.

In a second embodiment of the present invention, in a situation where the rotation speed of the control unit 2212 and the rotation speed of the rotation shaft 212 are not very fast, a stopping force acting on a control unit stopper 2234 applied by the detent 232 is not very big. In this situation, since the control unit stopper 2234 does not need high strength, it is possible to utilize the structure shown in FIG. 7. In this embodiment, a rotation shaft stopper 2231 is formed at a position that is on the external wall of the part of the rotation shaft drive unit 222 having the maximum external diameter, and is close to the control unit 2212. An control unit stopper 2234 is formed at a position that is on the external wall of the control unit 2212 and is close to the part of the rotation shaft drive unit 222 having the maximum external diameter; also the control unit stopper 2234 axially sticks out toward the part of the rotation shaft drive unit 222 having the maximum external diameter. The control unit stopper 2214 formed in this way makes an arm and is located at a position that approaches the rotation shaft stopper 2221. Furthermore, in this embodiment, there is a gap 2235 between the control unit stopper 2234 and the rotation shaft stopper 2231 along the rotation direction of the rotation shaft drive unit 222. By using this kind of structure, at the braking position, the detent 232 makes contact with the control unit stopper 2234 so that the rotation of the control unit 2212 is stopped; at this time, the control unit 2212 lets the spring 2213 release its fixed connection with the clutch gear 2211 so that the rotation of the clutch gear 2211 cannot be transmitted, and then the control unit 2212 is stopped. Furthermore there is the gap 2235 between the control unit stopper 2234 and the rotation shaft stopper 2231 along the rotation direction of the rotation shaft drive unit 222; therefore, from the time when the control unit 2212 stops rotating, the rotation shaft 212 continues to rotate a predetermined angle with respect to the control unit 2212 until the rotation shaft stopper 2231 makes contact with the control unit stopper 2234. When the rotation stopper 2231 makes contact with the control unit stopper 2234, the rotation of the rotation shaft drive unit 222 is stopped, and then the rotation of the rotation shaft 212 is stopped. In this way, the detent 232 can stop the rotation of the rotation shaft 212 by using the control unit stopper 2234.

In this embodiment, the stoppers (i.e. the control unit stopper 2234 and the rotation shaft stopper 2231) formed on the control unit 2212 and the rotation shaft drive unit 222 are bosses integrally formed together with the control unit 2212 and the rotation shaft drive unit 222, respectively. However, the present invention is not limited to this; those skilled in the art may make numerous modifications based on actual structures and actual demands. For example, the stoppers may be single members that are fixedly connected to the external surfaces of the control unit 2212 and the rotation shaft drive unit 222, respectively. That is, as long as the stoppers can be connected to the detent 232 so as to let the control unit 2212 and the rotation shaft drive unit 222 stop rotating, they are good.

In this embodiment, the detent 232 is made of sheet-shaped material. However, the present invention is not limited to this; those practiced in the art may make numerous modifications based on actual structures and actual demands. That is, as long as the detent 232 can be moved from the brake-off position to the braking position due to the electromagnetic force generated by the electromagnetic coil 231 and can be connected to the stopper of the control unit 2212, it is good.

In this embodiment, by letting two end faces of the control unit stopper 2214 and the rotation shaft stopper 2221, facing each other along the rotation direction of the rotation draft drive unit 222, be flat surfaces when viewed along the axial direction, it is possible to let the control unit 2212 and the rotation draft drive unit 222 unsimultaneously stop rotating. However, the present invention is not limited to this; those skilled in the art may make numerous modifications based on actual structures and actual demands. For example, it is possible to not let the contact part of the detent 232 and the control unit stopper 2214 as well as the contact part of the control unit stopper 2214 and the rotation shaft stopper 2221 be plane, or use a combination of the above-mentioned methods. That is, as long as the rotations of the control unit 2212 and the rotation shaft drive unit 2221 can be unsimultaneously stopped, they are good.

In the above-mentioned embodiments, although the paper feed tray 3 pivotally disposed on one side wall of the image formation apparatus 1 is used as an example for purpose of illustration, the present invention is not limited to this. The design concept of the present invention may be widely applied to the paper feed structures of various image formation apparatuses such as scanners, copiers, multifunction office machines, etc. Furthermore the present invention may be widely applied to structures in which the rotations of rotation members need to be controlled.

While the present invention is described with reference to the specific embodiments chosen for purpose of illustration, it should be apparent that the present invention is not limited to these embodiments, but numerous modifications could be made thereto by those skilled in the art without departing from the basic concept and scope of the present invention.

The present application is based on Chinese Priority Patent Application No. 201010003614.7 filed on Jan. 6, 2010, the entire contents of which are hereby incorporated by reference.

What is claimed is:

1. A paper feed device comprising:
a drive transmission unit disposed on one end of a rotation shaft, including a clutch gear, a control unit, and a spring, wherein, the clutch gear is axially oriented with respect to the rotation shaft, and is able to rotate around the rotation shaft; the control unit is used to control the spring so as to let the spring be fixedly connected to the clutch gear; one end of the spring is fixedly connected to the control unit, and another end of the spring is fixedly connected with respect to the rotation shaft; when the clutch gear is driven to rotate, the clutch gear drives the rotation shaft to rotate by using the spring;
a control unit stopper fixedly disposed on the control unit; and
an electromagnetic absorber including a detent, wherein, when the electromagnetic absorber is in a conducting state, the detent is located at one of a brake-off position and a braking position; when the electromagnetic absorber is in a non-conduction state, the detent is located at another of the brake-off position and the braking position; when the detent is located at the brake-off position, the detent and the control unit stopper are separated; when the detent is located at the braking position, the detent makes contact with the control unit stopper, and stops the rotation of the control unit by using the control unit stopper,
wherein,
the paper feed device further includes a rotation shaft stopper, and the rotation shaft stopper is fixedly connected with respect to the rotation shaft,
when the detent is located at the brake-off position, the control unit stopper and the rotation shaft stopper are separated,
when the detent is located at the braking position, the rotation of the control unit is stopped by using the control unit stopper, and from the time when the rotation of the control unit stops, the rotation shaft continues to rotate a predetermined angle with respect to the control unit to let the rotation shaft stopper make contact with the control unit stopper so that the detent stops the rotation of the rotation shaft by using the control unit stopper.

2. The paper feed device according to claim 1, wherein:
the drive transmission unit further includes a rotation shaft drive unit; the rotation shaft drive unit mates with one end of the rotation shaft, and is fixedly connected to the end of the rotation shaft along a rotation direction; the spring mates with the rotation shaft drive unit,
the control unit mates with the spring,
the other end of the spring is fixedly connected to the rotation draft drive unit along the rotation direction so that the other end of the spring is fixedly connected with respect to the rotation shaft,
the rotation shaft stopper is fixedly disposed on the rotation shaft drive unit so that the rotation shaft stopper is fixedly connected with respect to the rotation shaft.

3. The paper feed device according to claim 1, wherein:
the predetermined angle is 5 degrees ±3 degrees.

4. The paper feed device according to claim 2, wherein:
the control unit stopper is a boss disposed on the external wall of the control unit; the rotation shaft stopper is a boss disposed on the external wall of the rotation shaft drive unit.

5. The paper feed device according to claim 2, wherein:
the control unit is a sleeve.

6. The paper feed device according to claim 2, wherein:
the rotation shaft drive unit is a sleeve, and the sleeve has a stair-like axial cross-section.

7. An image formation apparatus comprising:
the paper feed device according to claim 1.
